(19) United States
(12) Patent Application Publication
(10) Pub. No.: US 2005/0122545 A1
(43) Pub. Date: Jun. 9, 2005

(54) Flexible high performance error diffusion

(76) Inventors: Sridharan Ranganathan, Chandler, AZ (US); Kalpesh Mehta, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/728,214

(22) Filed: Dec. 3, 2003

(51) Int. Cl. H04N 1/405

(52) U.S. Cl. 358/3.03

(57) ABSTRACT

In some embodiments, error diffusion is performed using two or more threads. Other embodiments are described and claimed.

### TECHNICAL FIELD

The inventions generally relate to error diffusion.

### BACKGROUND

Image processing in document imaging applications has traditionally been handled by fixed-function Application Specific Integrated Circuits (ASICs). Programmable solutions (for example, FPGAs, DSPs, etc) have not typically offered the price and performance required for these applications. The lack of scalable solutions meant that the products across the different performance segments could not be standardized on a common platform.

However, a high-performance, parallel, scalable, programmable processor targeted at document imaging solutions such as digital copiers, scanners, printers, and multi-function peripherals has been designed by Intel Corporation. The Intel MXP5800 Digital Media Processor provides the performance of an ASIC with the programmability of a processor. The architecture of this processor provides flexibility to implement a wide range of document processing image paths (for example, high page per minute monochrome, binary color, contone color, MRC-based algorithms, etc.) while accelerating the execution of frequently used imaging functions (color conversion, compression, and filter operations).

Error diffusion implementations are widely used in imaging and/or printing applications. Examples of such applications include document imaging solutions such as digital copiers, scanner, printers, and multi-function peripherals. Error diffusion may be used in such applications to convert a multi-level image to a bi-tonal (two level) image.

Error diffusion is a digital half toning technique used to convert images with a particular amplitude resolution to a domain with lower resolution. An example of error diffusion is the conversion of a grayscale image in which each pixel is represented by 256 levels (for example, “0” through “255”) to a bi-tonal image in which each pixel is represented by two levels (for example, “on” and “off”, or “0” and “1”). Error diffusion is a neighborhood process in which a quantization error is distributed to immediate neighbors of a pixel based on weights of the error diffusion filter. Error diffusion and related filtering techniques are described in the following articles: “A Review of Halftoning Techniques” by R. Ulichney, Color Imaging: Device-independent Color, Color Hardcopy, and Graphics Arts V, Proc. SPIE Vol. 3963, January 2000; and “Evolution of error diffusion” by Keith T. Knox, Journal of Electronic Imaging 8(4), October 1999, pp. 422-429.

The throughput of error diffusion implementations is preferred to be one output for every pixel per clock period. This could occur if one output is provided for every pixel if all of the computation required for determining the error happens in one clock cycle (that is, the latency would be one clock cycle). However, in some implementations the computations happen in a pipelined fashion to achieve a reasonable speed of operation. Due to sequential dependencies of filter implementations, a pixel cannot be processed until a result from all prior pixels is available. This reduces the throughput to less than one clock because an operation cannot commence until the error is known and available from the previous operation. For example, if the core pipeline used for calculating the error is three-deep, the throughput is reduced to ⅓rd. Therefore, even though the core pipeline may be able to sustain a maximum throughput of one clock per pixel, the sequential dependency of the implementation limits the throughput to 1/n, where n is the pipeline depth. An error diffusion implementation that overcomes these performance effects of sequential dependencies would be very beneficial.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 is a block diagram representation illustrating error diffusion of pixels using a Burkes Filter according to some embodiments of the inventions.

FIG. 2 is a block diagram illustrating a system in which some embodiments of the inventions may be implemented.

FIG. 3 is a block diagram of a processing apparatus according to some embodiments of the inventions.

FIG. 4 is a block diagram representation of a processing apparatus according to some embodiments of the inventions.

FIG. 5 is a block diagram representation of an Image Signal Processor (ISP) according to some embodiments of the inventions.

FIG. 6 is a block diagram representation of an apparatus according to some embodiments of the inventions.

FIG. 7 is a block diagram representation of an apparatus according to some embodiments of the inventions.

### DETAILED DESCRIPTION

Some embodiments of the inventions relate to error diffusion. In some embodiments two or more threads are used to perform imaging error diffusion. In some embodiments error diffusion is performed using concurrent multithreading.

Some embodiments use an architecture that overcomes obstacles inherent to pipelining of an error diffusion implementation using an n-way multithreaded mechanism. In some embodiments “n” is equal to three. In some embodiments a three-way multithreaded mechanism is used for three threads to operate on three consecutive rows in a raster. In some embodiments sequential dependencies are overcome by n threads operating on x consecutive rows in the raster. In some embodiments sequential dependencies between threads are overcome by forwarding data from one thread to another.

In some embodiments a first thread has an error input and a pixel input and produces an error output, and at least one other thread each has a pixel input and an error output, the at least one other thread producing an error output in response to the error output of the first thread. In some embodiments at least one of the first thread and/or other threads has two error inputs. In some embodiments two error value inputs are required for each filter operation (for example, for some three line filters). In some embodiments one or more of the threads have at least two error value inputs for each filter operation. In some embodiments all of the threads have at least two error value inputs for each filter operation.

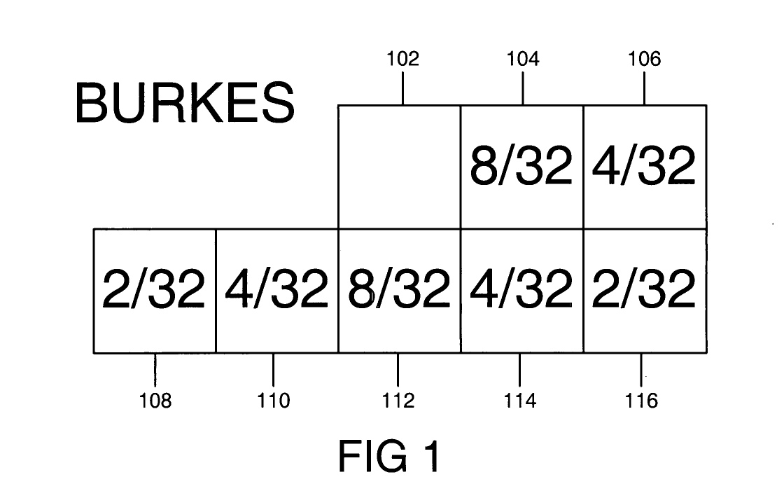

FIG. 1 illustrates a pixel representation 100 of a Burkes Filter. Pixel 102 is the current pixel for which a quantization error is being calculated. Pixels 104, 106, 108, 110, 112, 114 and 116 are pixels having corresponding data used to calculate the quantization error for pixel 102. In the implementation of FIG. 1 a weight is assigned to the values of each of the other pixels 104, 106, 108, 110, 112, 114 and 116. For example, as illustrated in FIG. 1 pixels 104, 106, 108, 110, 112, 114 and 116 are assigned weights of 8/32, 4/32, 2/32, 4/32, 8/32, 4/32 and 2/32, respectively.

As mentioned above, error diffusion is a neighborhood process in which the quantization error is distributed to the immediate neighbors of the pixel based on the weights of the filter. FIG. 1 illustrates a pixel representation of a Burkes Filter in which the quantization error is distributed to seven neighbors as determined by the weighted coefficients of the neighbors.

A 7-tap Burkes Filter is a two-row filter since errors are distributed to the current row and the next row. Larger filters such as a 12-tap filter in which the error is distributed over three rows may be used for better quality. An example of a 12-tap filter is a filter known as a “Stucki's Filter”.

Some implementations of error diffusion filters have been limited in performance due to the computing, latency and memory bandwidth requirements of the particular implementation. For example, using a straight-forward Burkes Filter to diffuse a single error to seven neighbors can result in seven multiplies, eight adds, seven normalizations and one compare. Additionally, seven accesses to memory are necessary (seven reads and seven writes) to update the seven errors of the neighbors. Further one input (one higher resolution pixel) and one output (lower resolution pixel) are necessary bandwidth requirements for each filter operation. The throughput of such an implementation can be maximized at one output for every pixel only if all the computation required for determining the error happens in one clock (one clock latency).

In some implementations it is useful to implement the process in a reverse order as shown by the pseudo code below:

E(r,c) = The quantization error of the pixel in row r and column c
input (r,c) = The input value (0,...., 255) of the pixel in row r and
column c
output (r,c) = The output value (0,1) of the pixel in row r and column c
Threshold = The comparison threshold value for the quantization
C0, C1, C2, C3, C4, C5 and C6 = The weight coefficients for the neighbor
pixels
sop_total = The sum-of-product (SOP) computed value

| | |
|---|---|
| 1. for i = 1 to Height | -- row |
| 2. for j = 1 to Width | -- column |

3. err0 := C0 * E(i−1, j−2);
4. err1 := C1 * E(i−1, j−1);
5. err2 := C2 * E(i−1, j);
6. err3 := C3 * E(i−1, j+1);
7. err4 := C4 * E(i−1, j+2);
8. err5 := C5 * E(i, j−2);
9. err6 := C6 * E(i, j−1);
10. sop_total := err0 + err1 + err2 + err3 + err4 + err5 + err6;
11. new_value:= input(i,j) + sop_total;
12. if (new_value) > Threshold
13. output(i,j) := 1;
14. E(i,j) := new_value − 255;
15. else
16. output(i,j) := 0;
17. E(i,j) := new_value;
18. end if;
19. end for;
20. end for;

In the pseudo code set forth above the errors for the relevant pixels that are positioned earlier in the raster order are read from memory and a sum-of-product (SOP) calculation is performed based on the filter coefficients. The actual pixel value is added to the SOP and compared with a threshold value to determine the output pixel value and the error value. The error value is then stored and the process is repeated for the next pixel in the raster order.

Using an error diffusion filter according to a reverse order implementation such as that of the pseudo code set forth above reduces the computational and memory bandwidth requirements of the system. Each filter operation requires seven multiplies, eight adds, one normalization and one compare. Additionally, seven input error reads and one input pixel read are necessary input bandwidth requirements for each filter operation, and one error write and one output pixel write are necessary bandwidth requirements for each filter output.

Additionally, the throughput of such an implementation could be maximized at one output for every pixel only if all the computation required for determining the error happens in one clock (one clock latency). However, in reality, the computation will typically be performed in a pipelined fashion to achieve reasonable speed of operation. Due to sequential dependencies in filter implementations, a pixel is not processed until the results from all the prior pixels are available. This creates a reduction in throughput to less than one clock since an operation cannot begin until the error from the previous operation is available. For example, if the core pipeline of the filter is three-deep, the throughput is reduced to ⅓rd. Even though the core pipeline can sustain a maximum throughput of one clock per pixel, the sequential dependencies limit the throughput to 1/n, where n is the pipeline depth.

Some embodiments overcome the performance effects of sequential dependencies. In some embodiments a pipelined implementation is used for core computations while decreasing bandwidth requirements on memory (and/or on the memory sub-system). In some embodiments a data-driven MIMD architecture is used.

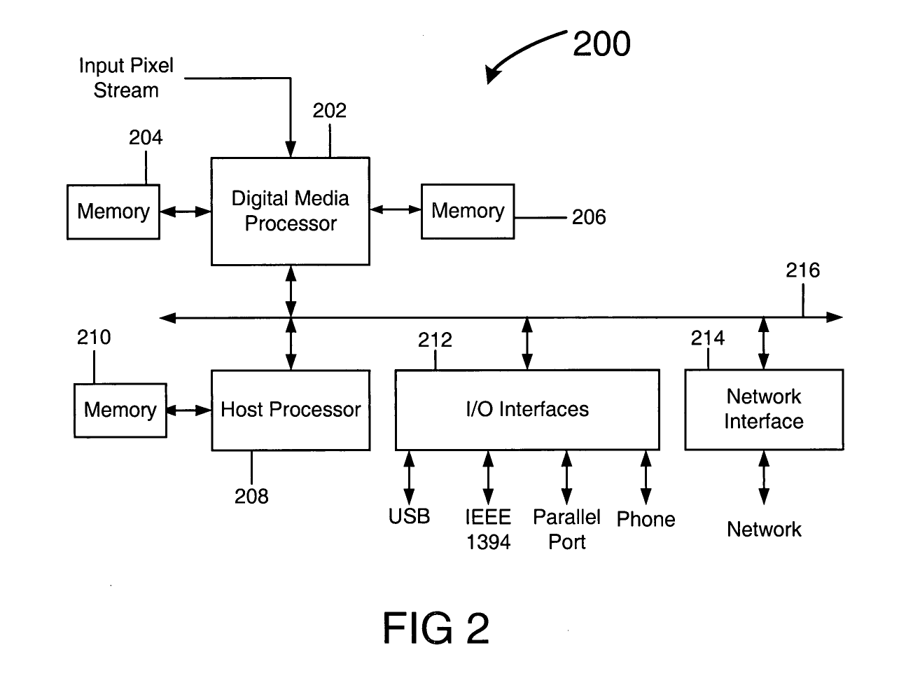

FIG. 2 illustrates a system 200 according to some embodiments. System 200 includes a processor 202 (for example, a digital media processor), a memory 204, a memory 206, a host processor 208, a memory 210, I/O interfaces 212, network interface 214 and a bus 216. In some embodiments bus 216 may be a PCI bus.

An input pixel stream is input to the digital media processor 202 for processing. Data read from one or more of the interfaces (for example, a Universal Serial Bus interface, an IEEE 1394 interface, a parallel port interface, a phone interface, a network interface, or some other interface) is processed by the digital media processor 202.

In some embodiments the digital media processor 202 may be any digital media processor. For example, digital media processor 202 may be an Intel MXP5800 Digital Media Processor.

Memory 204, memory 206 and/or memory 210 may be any type of memory. In some embodiments, one or more of memories 204, 206 and 210 may be DDR memory.

In some embodiments digital media processor 202 uses an external host processor (such as processor 208) for performing operations such as downloading microcode, register configuration, register initialization, interrupt servicing, and providing a general purpose bus interface for uploading and/or downloading of image data. In some embodiments a JTAG unit may be provided on the digital media processor 202 for performing these functions.

A digital media processor such as digital media processor 202 may be a single processing chip designed to implement complex image processing algorithms using one or more Image Signal Processors (ISPs) connected together in a mesh configuration using Quad ports (QPs). The quad ports can be configured (statically) to connect various ISPs to other ISPs or to external memory (for example, DDR memory) using DMA (Dynamic Memory Access) channels.

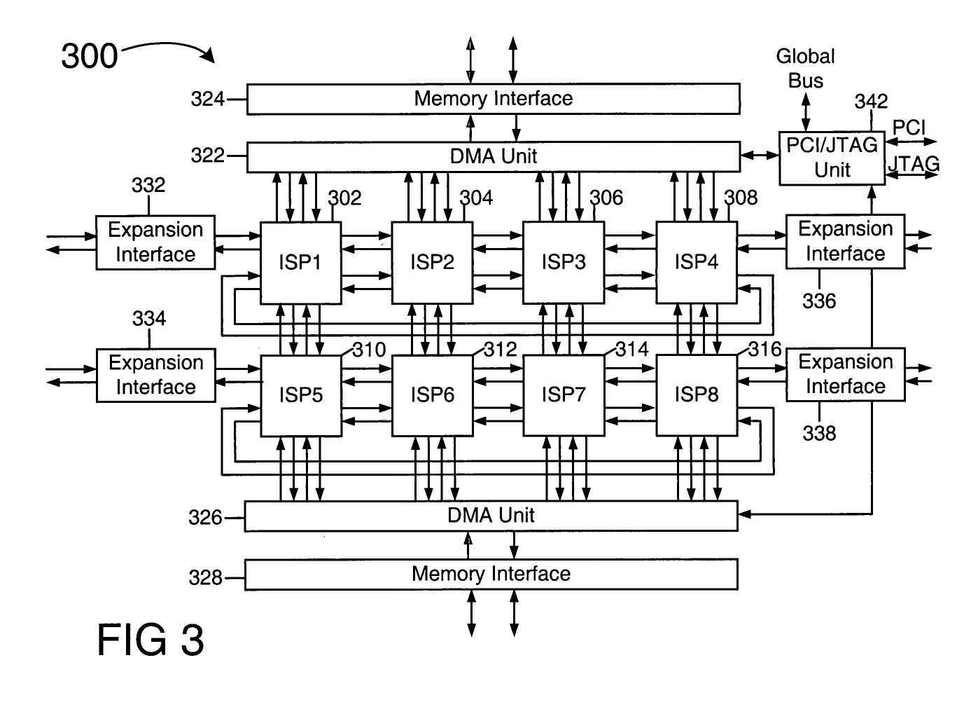

FIG. 3 illustrates a digital media processor 300 according to some embodiments. In some embodiments the digitial media processor 202 illustrated in FIG. 2 may be implemented using the same elements or similar elements as those of digital media processor 300 illustrated in FIG. 3. Digital media processor 300 includes an Image Signal Processor 302 (ISP1), an Image Signal Processor 304 (ISP2), an Image Signal Processor 306 (ISP3), an Image Signal Processor 308 (ISP4), an Image Signal Processor 310 (ISP5), an Image Signal Processor 312 (ISP6), an Image Signal Processor 314 (ISP7), an Image Signal Processor 316 (ISP8), a Direct Memory Access (DMA) unit 322, a memory interface 324, a DMA unit 326, a memory interface 328, an expansion interface 332, an expansion interface 334, an expansion interface 336, an expansion interface 338, and a PCI/JTAG unit 342.

The Image Signal Processors 302, 304, 306, 308, 310, 312, 314 and 316 are connected to each other using programmable ports referred to as quad ports (QPs). In some embodiments as illustrated in FIG. 3 each ISP has eight quad ports. Each quad port may be a bi-directional data connection that allows data to flow from one unit to another, and has the ability to send and receive data simultaneously through two separate unidirectional connections (e.g., buses). The quad port structure around an ISP is implemented such that all of the quad ports can talk to each other and to the ISP through a full crossbar connection called the quad port routing channel. The quad ports can be programmable.

The DMA units 322 and 326 can operate identically to each other. Each DMA unit, in conjunction with a corresponding memory controller, is responsible for transferring data in and out of memory. The memories are not illustrated in FIG. 3 and not necessarily part of the processor 300, but are connected to memory interface 324 and memory interface 328, respectively. The DMA units 322 and 326 connect the ISPs through quad ports to external memory. Each DMA channel is capable of simultaneous read and write operations.

The DMA units also can contain a PCI-channel which may be used for PCI transfers and used by a JTAG in a JTAG mode. The JTAG unit (which may either be combined as a PCI/JTAG unit 342 as illustrated in FIG. 3 or in a separate unit from the PCI unit) can also perform functions for the processor 300, including downloading microcode, register configuration, register initialization, interrupt servicing and/or uploading and/or downloading image data (for example, via the general purpose bus).

The expansion interface units 332, 334, 336 and 338 are programmable, and allow for a highly scalable architecture. They may be used to connect the processor 300 to other chips in a system (such as other similar processors or other chips). For example, the expansion units may be used to capture data from CMOS and/or CCD sensors, or to connect multiple processor chips together. This allows for high performance solutions (such as high page per minute solutions). The expansion interface units can be implemented using a simple point-to-point protocol, and the transmit and receive sides of each unit may be simultaneous and completely independent of each other.

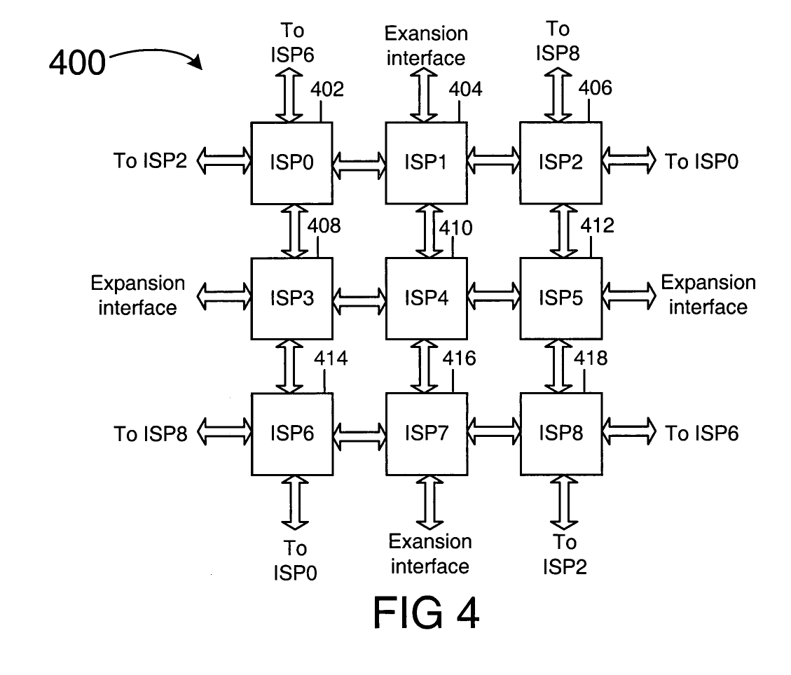

FIG. 4 illustrates an alternative arrangement 400 of Image Signal Processors within a digital media processor according to some embodiments. In some embodiments the digital media processor 202 illustrated in FIG. 2 may be implemented using the same elements or similar elements as those of the ISP arrangement 400 illustrated in FIG. 3.

Arrangement 400 includes an Image Signal Processor 402 (ISP0), an Image Signal Processor 404 (ISP1), an Image Signal Processor 406 (ISP2), an Image Signal Processor 408 (ISP3), an Image Signal Processor 410 (ISP4), an Image Signal Processor 412 (ISP5), an Image Signal Processor 414 (ISP6), an Image Signal Processor 416 (ISP7), and an Image Signal Processor 418 (ISP8). The ISPs of FIG. 4 may be connected with each other using quad ports as described in reference to the ISPs of FIG. 3, and may be part of a digital media processor similar to processor 300 of FIG. 3. Additionally, the ISPs of FIG. 4 may be connected to one or more DMA units, PCI/JTAG units, Expansion Interface Units (for example to ISPs 404, 408, 412 and 416), etc. in a manner similar to the processor 300 of FIG. 3. They may be connected using a quad port structure or in any other manner.

An Image Signal Processor (ISP) can include several programming elements (PEs) connected together through a register file switch that provides a fast and efficient interconnect mechanism. The architecture can be used to maximize performance for data-driven applications by mapping individual threads to PEs in such a way as to minimize communication overhead. Each PE within an ISP can implement a part of the implementation, and data flows from one PE to another and from one ISP to another until it is completely processed.

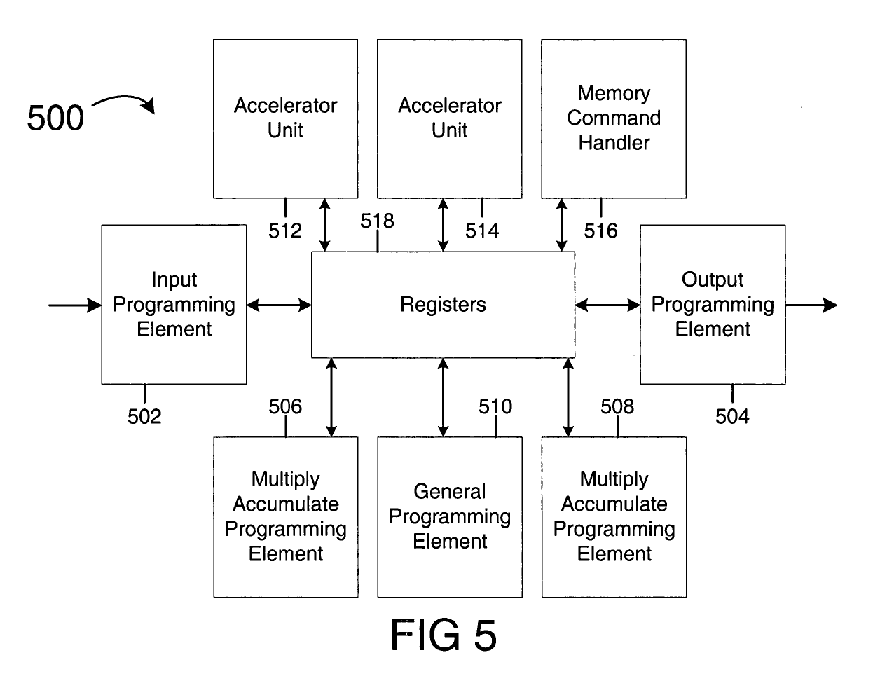

FIG. 5 illustrates an Image Signal Processor (ISP) 500 according to some embodiments. ISP 500 may be the same as or similar to all or some of the ISPs illustrated herein (for example, in FIG. 3 and FIG. 4). ISP 500 includes an input programming element (IPE) 502, an output programming element (OPE) 504, a multiply accumulate programming element (MACPE) 506, a MACPE 508, a general programming element (GPE) 510, an accelerator unit 512, an accelerator unit 514, a memory command handler (MCH) 516 and registers 518 (which may be general purpose registers). IPE 502 and OPE 504 may be used as gateways to other ISPs (for example, through quad ports) and may also be programmed to perform some level of processing. Other PEs within the ISP 500 provide special processing capabilities. The MCH 516 (and associated memory within ISP 500) are provided within the ISP 500 for use by the PEs. Data is sent to the IPE and OPE through a register interface which is then communicated with external memory (for example, DDR memory) through the quad ports. The MCH 516 may be used as local storage to store data such as error data, thus minimizing the bandwidth requirement of external memory.

The general programming element (GPE) 510 is a basic programming element. The other Programming Elements (PEs) such as the Input Programming Element (IPE) 502, the Output Programming Element (OPE) 504, the Multiply Accumulate Programming Element (MACPE) 506, and the Multiply Accumulate Programming Element (MACPE) 508 have additional functionality. Each of the Programming Elements in FIG. 5 may have local registers, indirect registers, instructions that support flow control, an Arithmetic Logic Unit (ALU), instructions that support arithmetic and logic functions, and may also have custom instructions. For example, the MACPE has multiply accumulate instructions and the GPE has bit rotation instructions. All PEs support all flow control and ALU instructions.

The IPE 502 is a GPE connected to the quad ports to accept incoming data streams. The IPE 502 may be built on a GPE, minus the bit rotation instructions, with the quad port interface as the input port. All the instructions have the quad ports as additional input operands along with local registers and general purpose registers 518.

The OPE 504 is a GPE connected to the quad ports to send outgoing data streams. The OPE 504 may be built on a GPE, minus the bit rotations instructions, with the quad port interface as the output port. All the instructions have the quad ports as additional output operands along with the local registers and general purpose registers 518.

The MACPE 506 and MACPE 508 may be a GPE enhanced with multiply and accumulate functions. The MACPEs 506 and 508 may be built on a GPE, minus the bit rotation instructions, and with enhanced math support. The units may support multiply and accumulate instructions, and can provide a wide range of arithmetic and logic functions useful for implementing image-processing implementations.

The ISP 500 may be optimized for a particular task. The hardware accelerator units 512 and/or 514 (and/or other hardware accelerator units within ISP 500) may reflect the optimization of the ISP 500. For example, each of the hardware accelerators 512, 514 (and/or others within ISP 500) may be one or more of the following: 2D triangular filters (variable-tap and/or single-tap), single triangular filter, variable triangular filter, bi-level text encoder/decoder, G4 accelerator, Huffman encoder/decoder, JPEG encoder/decoder, JPEG decoder, etc.

The Memory Command Handler (MCH) 516 may include or be attached to data RAM to allow for local storage of data, constants and instructions within an ISP. The MCH 516 provides a scalable mechanism for local storage optimized for access patterns characteristic of image processing. The MCH provides access to the data in a structured pattern, which is often required by image processing (for example, by component, by row, by column, by 2D block, etc.). The unit can support independent data streams using Memory Address Generators (MAGs). An arbiter on a clock cycle basis may control access to the memory. The MCH 516 may be programmed through the global bus for all commands to the MAGs. Data to the memory bank (and/or some commands) may be communicated through the registers 518. The MCH 516 may include an SRAM block, MAG units, an arbiter that accepts requests for access to the SRAM block from the MAG units and arbitrates for ownership of the memory control, address and data buses, and a general purpose register interface for connecting the MAG units to the registers for passing data and commands to and from the SRAM block via the MAGs. The MCH is attached to or includes memory internal to the ISP for local data and variable storage, and to alleviate bandwidth bottlenecks that may be inherent in off-chip DDR memory, for example.

The registers 518 allow the PEs to exchange data, and may be used as general purpose registers. Data valid bits may be used to implement a semaphore system to coordinate data flow and register ownership by the PEs. The PEs may be forced to follow a standard predefined semaphore protocol when sharing data to and from the general purpose register block.

Any of the Programming Elements (PEs) within an ISP such as ISP 500 may be used to perform error diffusion according to some embodiments. Additionally any other PEs within an ISP such as ISP 500 (but not illustrated in or described in reference to FIG. 5 and ISP 500) may be used to perform error diffusion according to some embodiments. In some embodiments an error diffusion solution is designed to be integrated within the ISP in the form of one PE or more than one PEs. The MCH may be used as local storage to store error data. This can allow for a minimization of the bandwidth requirement of external memory.

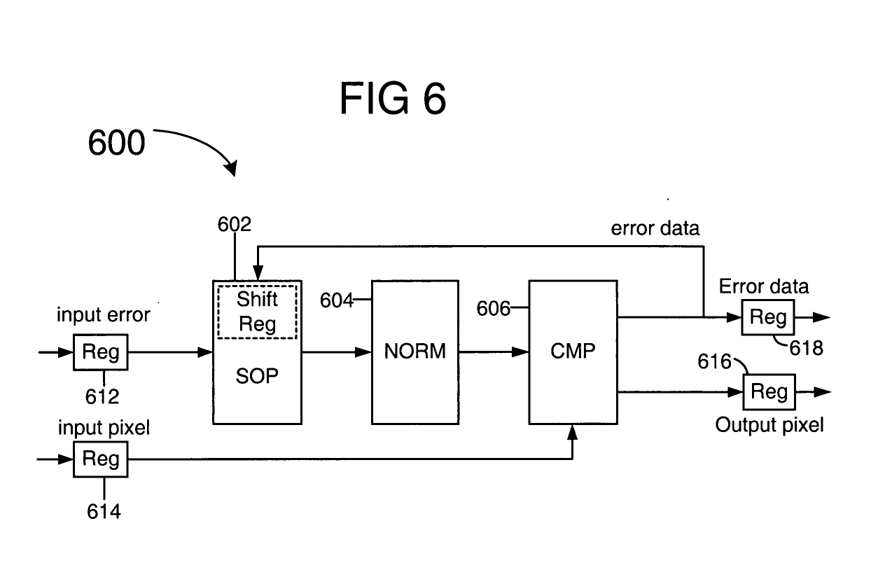

FIG. 6 illustrates a core pipeline 600 according to some embodiments. Pipeline 600 illustrated in FIG. 6 is a three-stage error diffusion core pipeline, but could also be any other type of arrangement, and need not be the same as the error diffusion core pipeline illustrated in FIG. 6 and described in reference thereto. For example, in some embodiments an error diffusion core pipeline may have some other number of stages than three (for example, a four-stage core pipeline).

Pipeline 600 includes a sum-of-products (SOP) stage 602, a normalization stage 604 and a compare stage 606. SOP stage 602 may include a shift register, as shown in dotted lines within SOP 602 in FIG. 6. In some embodiments, the shift register may be a separate element, stage, device, etc., not necessarily included within the SOP 602.

An input error is input to the SOP stage 602 (for example, from a register 612). An output of the SOP stage 602 is coupled to an input of the normalization stage 604, and an output of the normalization stage 604 is coupled to an input of the compare stage 606. Compare stage 606 adds an input pixel (for example, from a register 614) with the output from the normalization stage, and compares the result with a threshold value. The result of the comparison provides a lower resolution output pixel that is stored in register 616. Based on the result of the comparison, the error data output is input to the SOP stage 602 and also stored in register 618.

In some embodiments, for a 7-tap filter, six of the seven errors in the SOP calculation are stored locally in the shift register. The seventh error is computed in the compare stage 606, and is forwarded to the SOP stage 602 for computation of the error term. There are three stages between a consumer and a producer of the data. Therefore, in some embodiments, it is beneficial to have three threads execute concurrently to keep the core pipeline busy in every cycle. Concurrent multithreading enables performance to be optimized by eliminating idle cycles in the hardware pipeline. A thread can be, for example, one or more paths or routes of execution inside a program, routine, process, or context. Threaded programs can allow background and foreground action to take place without overhead of launching multiple processes or inter-process communication, for example.

In some embodiments an architecture may be used to overcome obstacles in error diffusion implementations which are inherent to pipelining by using a multithreaded mechanism. The mechanism can use n threads, where n may be any number that is two or greater. In some embodiments three threads are used. The three threads can be used to operate on three consecutive rows in the image processing raster. Sequential dependencies between threads may be overcome by forwarding data from one thread to another.

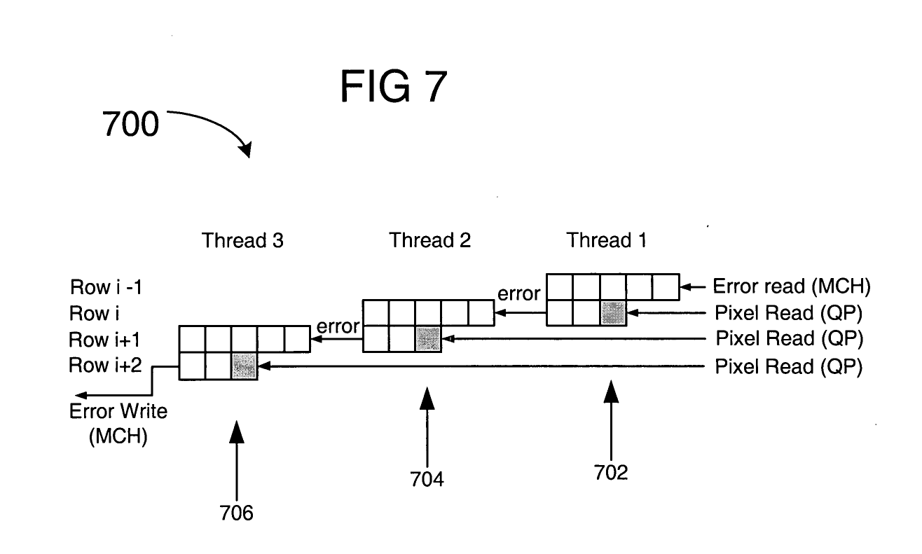

FIG. 7 illustrates an apparatus 700 according to some embodiments. Apparatus 700 illustrates data forwarding in a three-way multi-threaded implementation of error diffusion (for example, an error diffusion filter). Apparatus 700 includes Thread 1 (702), Thread 2 (704) and Thread 3 (706). Pixel values are read from external memory (for example, through quad ports), and may be made available through a register switch via an Input Programming Element (IPE). Errors produced by Thread 1 (702) are forwarded to Thread 2 (704). Errors produced by Thread 2 (704) are forwarded to Thread 3 (706). The error produced by Thread 3 (706) may be written to local storage (for example, using an MCH of an ISP), and is read by Thread 1 (702) when the next three rows in the raster are processed. By processing pixels from different rows in the manner illustrated in FIG. 7, throughput may be maximized at one pixel per clock. Additionally, this approach allows for a significant minimization of the burden on local storage such as the local memory associated with an MCH, since numerous reads and writes are not constantly occurring as with other implementations. Without using multithreading (for example, as illustrated in FIG. 7), the three pixels being operated upon would require three reads and three writes to local memory. By forwarding errors from one thread to another, the three pixels only require one read and one write. That is, the bandwidth requirement may be reduced by a factor of three in this example.

A pixel is read into the bottom right box of Thread 1 (702) (for example, via a quad port of an ISP). At the same time a new error value is read into the top right box of Thread 1 (702) (for example, from a local memory via a memory command handler of an ISP). The value of the pixel read into the bottom right box and error values in the other seven boxes are used to calculate a new error value for the pixel of the bottom right box. Then the error values are all shifted to the box to the left and a new error value is read into the top right box and a new pixel value is read into the bottom right box. The other threads operate in a similar manner, but the error value read into the top right box of those threads is provided as an output of the previous thread (for example, the error value from the lower left box of Thread 1 is transferred into the top right box of Thread 2). The rows for the various threads are staggered as illustrated in FIG. 7 to ensure that the correct dependency requirements are met. In this manner, separate error value reads and writes are not necessary for each thread as each new value is calculated. Only one error read and one error write is necessary for each clock for all three threads.

The embodiments illustrated in FIG. 7 using three threads are advantageously used for an implementation in a system with a core pipeline having three stages, for example. Such an implementation is beneficial, for example, in conjunction with the pipeline illustrate in FIG. 6. In such an embodiment complex image processing may be implemented while keeping the core pipeline busy in every cycle. Any use of two or more threads may be made in various embodiments. However, increasing the number of threads beyond three in conjunction with the pipeline of FIG. 6 (that is, a three-stage pipeline) may not increase the throughput, which is already maximized at one pixel per clock using the three thread embodiments of FIG. 7. However, it is noted that the bandwidth requirement may be reduced by a factor of 1/n, where n is the number of threads. Increasing the number of threads does, however, add to the complexity of the design, and may require registers for storing the context of the thread. In any case, an architecture such as that of FIG. 6 and FIG. 7 may be chosen to provide flexibility to tradeoff design complexity in order to reduce memory bandwidth without any impact to the throughput of the system. In some embodiments rows are staggered so that dependencies are not violated.

The embodiments of FIG. 7 have been described for a generic 7-tap filter in which errors are distributed to neighbors in the current and previous rows (that is, two rows). However, other embodiments may be used for any number of taps, number of rows, frequency of operation, etc. For larger filters that straddle more than two rows, two or more error values may need to be forwarded from one thread to another. Additionally, the number of shift registers that temporarily store the error values and the number of multipliers and adders may also be scaled accordingly so that a throughput of one pixel per clock can still be achieved for a larger filter.

In some embodiments flexibility is provided to implement alternative extensions for larger filters. For example, additional hooks may be provided for a 7-tap filter implementation to let users use it to implement a 12-tap 3-row filter (possibly with a performance penalty). In some embodiments a MACPE or any other PE could do part of the computation to provide a tightly coupled high performance implementation. In some embodiments the same hardware may be used to implement a 7-tap filter for highest performance and a 12-tap filter with reasonable performance, for example.

In some embodiments error diffusion is implemented that overcomes challenges posed by the sequential nature of the implementation. Multithreading and/or data-forwarding may be used to enable the pipeline to be fully utilized while optimizing the throughput and bandwidth requirements of the system. The throughput may be maximized at one pixel per clock. The bandwidth requirement may be reduced by a factor of n, where n is the number of threads in the system. In some embodiments the architecture may be scalable and enable a variety of filter sizes and values to be implemented without comprising the performance. In some embodiments the architecture is particularly well suited for a MIMD (Multiple Instructions Multiple Data) machine such as the Intel MXP5800 Digital Media Processor.

While some embodiments have been illustrated and/or described as being performed in conjunction with or by a digital media processor such as an Intel MXP5800 Digital Media Processor, the inventions are not limited to implementations performed by or in conjunction with this or any other digital media processor or any other processor, except as specifically recited in the following claims, if applicable. Further, while some embodiments have been described in reference to particular types of error diffusion or filters such as Burkes filters, Stucki's filters, 7-tap 2-row filters, 12-tap 3-row filters, etc., the inventions are not limited to implementations relying on these specific types of error diffusion and/or filters.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams may have been used herein to describe embodiments, the inventions are not limited to those diagrams or to corresponding descriptions herein. For example, flow need not move through each illustrated box or exactly in the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

1. An imaging error diffusion apparatus comprising:
a first thread having an error input and a pixel input and producing an error output; and
at least one other thread each having a pixel input and an error input, the at least one other thread producing an error output in response to the error output of the first thread.

2. The apparatus as claimed in claim 1, wherein the at least one other thread is at least two threads, where each of the other threads has an error input coupled to an error output of another thread.

3. The apparatus as claimed in claim 1, wherein the first thread receives error data of a previous row and pixel data of a current row and the at least one other thread receives error data of the current row and pixel data of a subsequent row.

4. The apparatus as claimed in claim 1, wherein the apparatus is included within an image signal processor.

5. The apparatus as claimed in claim 1, wherein the apparatus is included within a digital media processor.

6. The apparatus as claimed in claim 1, wherein a total number of the first thread and the at least one other threads is equal to or greater than a number of stages in an error diffusion hardware pipeline.

7. The apparatus as claimed in claim 6, wherein the total number of the first thread and the at least one other threads is equal to the number of stages in the error diffusion hardware pipeline.

8. The apparatus as claimed in claim 7, wherein the total number of the threads and the number of the stages is three.

9. The apparatus as claimed in claim 1, wherein each of the first thread and the at least one other threads execute concurrently.

10. The apparatus as claimed in claim 1, wherein the first thread has a second error input.

11. The apparatus as claimed in claim 10, wherein each of the at least one other threads has a second error input.

12. The apparatus as claimed in claim 1, wherein each of the at least one other threads has a second error input.

13. An imaging error diffusion method comprising:
receiving at a first thread an error input and a pixel input and producing an error output; and
receiving at a second thread a pixel input and the error output of the first thread and producing an error output in response to the error output of the first thread.

14. The method of claim 13, further comprising the first thread calculating an error value for a current pixel based on the pixel input, the error input and at least one other previously calculated error value within the first thread.

15. The method of claim 13, further comprising receiving at a third thread a pixel input and the error output of the second thread and producing an error output in response to the error output of the second thread.

16. The method of claim 13, wherein the first thread and the second thread execute concurrently.

17. The method of claim 13, wherein the first thread receives a second error input.

18. The method of claim 17, wherein the second thread receives a second error input.

19. The method of claim 13, wherein the second thread receives a second error input.

20. A system comprising
a memory; and
a processor coupled to the memory; and
an imaging error diffusion apparatus comprising:
a first thread having an error input and a pixel input and producing an error output; and
at least one other thread each having a pixel input and an error input, the at least one other thread producing an error output in response to the error output of the first thread.

21. The system as claimed in claim 20, wherein the error output of the first thread is not stored in memory.

22. The system as claimed in claim 20, wherein the error output of the first thread is not stored in any memory external to the threads.

23. The system as claimed in claim 20, wherein a total number of the first thread and the at least one other threads is equal to or greater than a number of stages in an error diffusion hardware pipeline included in the processor.

24. The system as claimed in claim 23, wherein the total number of the first thread and the at least one other threads is equal to the number of stages in the error diffusion hardware pipeline.

25. The apparatus as claimed in claim 24, wherein the total number of the threads and the number of the stages is three.

26. The apparatus as claimed in claim 20, wherein each of the first thread and the at least one other threads execute concurrently.

27. The system as claimed in claim 20, wherein the first thread has a second error input.

28. The system as claimed in claim 27, wherein each of the at least one other threads has a second error input.

29. The apparatus as claimed in claim 20, wherein each of the at least one other threads has a second error input.
